(19) United States
(12) Patent Application Publication
(10) Pub. No.: US 2019/0137801 A1
(43) Pub. Date: May 9, 2019

(54) SEAL MATERIAL FOR LIQUID CRYSTAL DISPLAY DEVICE AND LIQUID CRYSTAL DISPLAY DEVICE

(71) Applicant: SHARP KABUSHIKI KAISHA, Sakai City (JP)

(72) Inventor: MASANOBU MIZUSAKI, Sakai City (JP)

(21) Appl. No.: 16/182,131

(22) Filed: Nov. 6, 2018

(30) Foreign Application Priority Data
Nov. 6, 2017 (JP) 2017-214042

(51) Int. Cl. G02F 1/1339; G02F 1/137; C09J 163/00; C09J 11/04; C09K 19/06; C09K 19/30; B01J 20/16

(52) U.S. Cl. CPC G02F 1/1339; G02F 1/137; C09J 163/00; C09J 11/04; C09K 19/063; G02F 2202/28; B01J 20/16; G02F 2001/13712; G02F 2001/13706; G02F 2201/501; G02F 2203/02; C09K 19/3066

(57) ABSTRACT

A seal material for liquid crystal display device comprising a seal ingredient including an epoxy monomer and a curing agent, and a moisture absorbent, wherein the moisture absorbent comprises a crystalline compound containing SiOₓ (wherein x=1 or higher to 8 or lower) and AlO_{y} (wherein y=1 or higher to 8 or lower); and the moisture absorbent is contained 5 mass % or more to 18 mass % or less with respect to a total amount of the above-described seal material for liquid crystal display device.

### CROSS-REFERENCE TO RELATED APPLICATIONS

This application is related to Japanese application No. 2017-214042 filed on Nov. 6, 2017, whose priority is claimed under 35 USC § 119, the disclosure of which is incorporated by reference in its entirety.

### FIELD OF THE INVENTION

The present invention relates to a seal material for liquid crystal display device and a liquid crystal display device. More particularly, the present invention relates to the seal material for liquid crystal display device that is high in moisture permeation resistance and to the liquid crystal display device whose perimeter is at least partly sealed with the seal material. The seal material for liquid crystal display device of the present invention is especially useful for manufacturing liquid crystal display devices that require moisture permeation resistance, such as liquid crystal display devices in which a highly-hygroscopic liquid crystal compound is used, narrow-frame liquid crystal display devices, and reflective liquid crystal display devices.

### BACKGROUND OF THE INVENTION

A liquid crystal display device is configured to sandwich a liquid crystal compound-containing liquid crystal layer between a pair of substrates. A pair of the substrates is sealed at its periphery with a seal material so as to prevent an outflow of the liquid crystal compound and harmful effects on the liquid crystal layer caused by an outside environment (see Japanese Unexamined Patent Publication No. 2009-301025: Patent Literature 1).

The seal material is required to have various properties such as high adhesion strength and heat resistance. For example, Japanese Unexamined Patent Publication No. 2005-308941 (Patent Literature 2) describes moisture permeation resistance as one of the required properties, which is to prevent moisture from entering a liquid crystal display device.

Patent Literature 2 describes as follows: a seal material comprises an inorganic filler formed of granules; a content of the inorganic filler is within a specific range; and a total surface area of the granules of the inorganic filler in the seal material is within a specific range, resulting in the seal material having the moisture permeation resistance. Patent Literature 2 exemplifies, as the inorganic filler, silica, alumina, titanium oxide, magnesium oxide, zirconium oxide, etc.

### DESCRIPTION OF THE RELATED ART

### Patent Literatures

Patent Literature 1: Japanese Unexamined Patent Publication No. 2009-301025

Patent Literature 2: Japanese Unexamined Patent Publication No. 2005-308941

### BRIEF DESCRIPTION OF THE INVENTION

However, the liquid crystal display device was insufficient in moisture permeation resistance, which uses the seal material comprising the inorganic filler, such as silica, alumina, titanium oxide, magnesium oxide, or zirconium oxide; and such a liquid crystal display device was likely to be involved with a decrease in voltage holding ratio (VHR) caused by moisture from an outside environment permeating a liquid crystal layer.

In recent years, liquid crystal display devices having a larger display area-namely, having a narrower frame-have been desired. Inevitably, an area from an edge of the liquid crystal display device, where the seal material is to be placed in order to seal the device, becomes smaller; and thus a distance between the outside environment and the liquid crystal layer becomes closer, with the result that the device is configured to have a structure in which moisture from the outside environment is likely to permeate the liquid crystal layer; therefore, it is desired that the moisture permeation into the liquid crystal layer should be effectively prevented.

For liquid crystal display devices, such as smart phones, which may be often used outdoors, reflective display means may be employed, which uses light from the outside. It is possible in this display means that a liquid crystal compound low in refractive index anisotropy (Δn) is used in the liquid crystal layer in order to improve contrasts. Many of liquid crystal compounds having this low Δn have a hygroscopic group such as a carboxyl group; therefore, in view of the use of such a compound, it is desired that the moisture permeation from the outside environment into the liquid crystal layer should be effectively prevented.

After studying various moisture absorbents, the inventor of the present invention found that a liquid crystal display device having improved moisture permeation resistance can be provided by allowing a seal material to comprise a crystalline moisture absorbent containing an ingredient represented by a specific formula, and achieved the present invention.

One aspect of the present invention provides a seal material for liquid crystal display device comprising a seal ingredient including an epoxy monomer and a curing agent, and a moisture absorbent, wherein the moisture absorbent comprises a crystalline compound containing SiOₓ (wherein x=1 or higher to 8 or lower) and AlO_{y} (wherein y=1 or higher to 8 or lower); and the moisture absorbent is contained 5 mass % or more to 18 mass % or less with respect to a total amount of the above-described seal material for liquid crystal display device.

Another aspect of the present invention provides a liquid crystal display device comprising:

a liquid crystal layer comprising a liquid crystal material;
a sealing placed so as to surround the liquid crystal layer in plan configuration; and
a pair of substrates having the liquid crystal layer sandwiched therebetween,
wherein the sealing is a cured material made of a seal material for liquid crystal display device comprising a seal ingredient including an epoxy monomer and a curing agent, and a moisture absorbent,
wherein the moisture absorbent comprises a crystalline compound containing SiOₓ (wherein x=1 or higher to 8 or lower) and AlO_{y} (wherein y=1 or higher to 8 or lower), and the moisture absorbent is contained 5 mass % or more to 18 mass % or less with respect to a total amount of the seal material for liquid crystal display device.

### BRIEF DESCRIPTION OF THE SEVERAL VIEWS OF THE DRAWINGS

FIGS. 1 (a) to (c) show schematic views of crystal structures composed of SiO₄—AlO₄.

FIG. 2 illustrates a schematic view of a liquid crystal display device of the present invention.

FIG. 3 illustrates a schematic view of a sample for evaluation of adhesion strengths in Example 2.

### DETAILED DESCRIPTION OF THE INVENTION

The seal material for liquid crystal display device and the liquid crystal display device of the present invention can increase a voltage holding ratio (VHR) of the liquid crystal display device and can increase reliability of display quality.

Hereinafter the present invention will be described in more detail.

The seal material for liquid crystal display device (hereinafter also referred to simply as “seal material”) comprises the seal ingredient including the epoxy monomer and the curing agent, which is to cure the epoxy monomer, and the moisture absorbent.

### (1) Seal Ingredient

### (a) Epoxy Monomer

As the epoxy monomer, any curable epoxy resin can be usually used. Examples of this epoxy resin include phenol novolac epoxy resins, cresol novolac epoxy resins, biphenyl novolac epoxy resins, trisphenol novolac epoxy resins, dicyclopentadiene novolac epoxy resins, bisphenol A epoxy resins, bisphenol F epoxy resins, 2,2′-diallylbisphenol A epoxy resins, bisphenol S epoxy resins, hydrogenated bisphenol. A epoxy resins, propylene oxide addition bisphenol A epoxy resins, biphenyl-type epoxy resins, naphthalene-type epoxy resins, resorcinol-type epoxy resins, and glycidyl amines.

Of the above-mentioned epoxy resins, the following are commercially available, for example: NC-3000S (manufactured by Nippon Kayaku Co., Ltd.) as the phenol novolac epoxy resin, EPPN-501H (manufactured by Nippon Kayaku Co., Ltd.) as the trisphenol novolac epoxy resin, NC-7000(manufactured by Nippon Kayaku Co., Ltd.) as the dicyclopentadiene novolac epoxy resin, Epiclon 840S and Epiclon 850CRP (both manufactured by Dainippon Ink and Industry Co., Ltd.) as the bisphenol A epoxy resins, Epikoto 807 (manufactured by Japan Epoxy Resin Inc.) and Epiclon 830 (manufactured by Dainippon Ink and Industry Co., Ltd.) as the bisphenol F epoxy resins, RE 310NM (manufactured by Nippon Kayaku Co., Ltd.) as the 2,2′-diallyibisphenol A epoxy resin, Epiclon 7015 (manufactured by Dainippon Ink and Industry Co., Ltd.) as the hydrogenated bisphenol epoxy resin, EPOXY ESTER 3002A (manufactured by Kyoeisha Chemical Co., Ltd.) as the propylene oxide addition bisphenol A epoxy resin, Epikoto YX-4000H and YL-6121H (both manufactured by Japan Epoxy Resin Inc.) as the biphenyl-type epoxy resins, Epiclon HP-4032 (manufactured by Dainippon Ink and Industry Co., Ltd.) as the naphthalene-type epoxy resin, Denacol EX-201 (manufactured by Nagase ChemteX Corporation) as the resorcinol-type epoxy resin, and Epiclon 430 (manufactured by Dainippon Ink and Industry Co., Ltd.) and Epikoto 630 (manufactured by Japan Epoxy Resin Inc.) as the glycidyl amines.

### (b) Curing Agent

The curing agent is not particularly limited, as long as the agent can cure the epoxy monomer.

Although the curing agent is not particularly limited, the curing agent is desirable that can cure the epoxy monomer at a temperature from 90° C. or higher to 150° C. or lower. The curing agent is more desirable that contains an amine and/or a thiol group, both of which are high in low-temperature reactivity. Examples of such a curing agent include hydrazide compounds such as 1,3-bis[hydrazinocarbonylethyl-5-isopropyl hydantoin] and adipic dihydrazide; dicyandiamide; guanidine derivatives; 1-cyanoethyl-2-phenylimidazole; N-[2-(2-methyl-1-imidazolyl)ethyl]urea; 2,4-diamino-6-[2′-methylimidazolyl-(1′)]-ethyl-s-triazine; N,N′-bis(2-methyl-1-imidazolylethyl)urea; N,N′-(2-methyl-1-imidazolylethyl)-adipoamide; 2 -phenyl-4-methyl-5-hydroxymethylimidazole; 2-imidazoline-2-thiol; 2,2′-thiodiethanethiol; and addition products having any of various amines and epoxy resins. These may be used independently, or two or more kinds may be used in combination.

The curing agent ray contain 0.1 part by mass (pbm) or more to 60 pbm or less with respect to 100 pbm of the epoxy monomer.

### (2) Moisture Absorbent

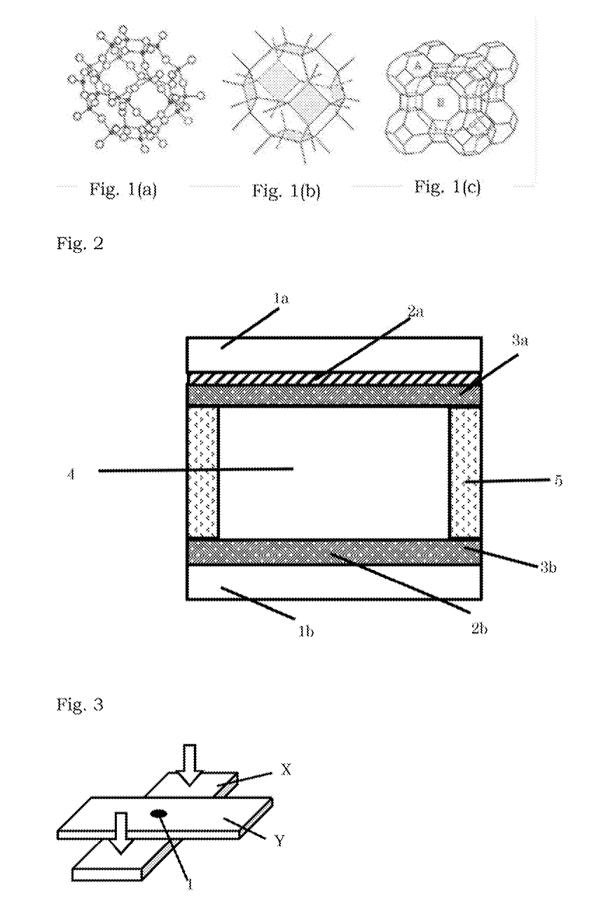

The moisture absorbent comprises the crystalline compound containing SiOₓ (wherein x=1 or higher to 8 or lower)and AlO_{y} (wherein y=1 or higher to 8 or lower). The crystalline compound has a structure, for example, illustrated in FIG. 1(a), and has a polyhedral structure by being further enlarged as illustrated in FIG. 1(b). The crystalline compound may have pores A and B as illustrated in FIG. 1(c) and is capable of absorbing water molecules and oxygen molecules in these pores. Usually both the pores A and B absorb the water molecules, and the pores B absorb the oxygen molecules. This crystalline compound is configured to be surrounded by molecules of SiO₄, which is high in compatibility with organic compounds, at its periphery (see FIG. 1(a)); therefore, the crystalline compound is likely to be compatible with the epoxy monomer-containing seal material (as a seal material for vacuum injection or a seal material for ODF, for example) to be used for the liquid crystal display device. Molecules of such a crystalline compound thus disperse uniformly in the seal material and are capable of effectively preventing water from entering the liquid crystal layer, which is caused by the moisture permeation. By using such a seal material that effectively prevents the moisture entry, the liquid crystal display device, as will be detailed below, can improve in long-term reliability, which has the liquid crystal layer containing the low-Δn liquid crystal material having the carboxyl group.

The moisture absorbent is riot particularly limited, as long as the moisture absorbent contains the above-described crystalline compound. Usable as the moisture absorbent is, for example, zeolite, which is commonly used. The zeolite may be represented by the general formula: M₂O.aSiO₂.Al₂O₃ wherein M represents an alkali metal, H⁺, or NH₄⁺; and “a”=2 or more to 6 or less. As examples of the alkali metal there may be mentioned lithium (Li), sodium (Na), and potassium (K). “a” being 2 or more to 6 or less means that Si/Al is 1 or more to 3 or less. From the viewpoint of easily obtaining the zeolite and lowering production costs, “a” is preferably 2 or more to 4 or less; and “a” is more preferably 2.

Examples of the zeolite include those having the following types in a zeolite structure stipulated by International Zeolite Association (IZA): LTA, FAU, ABW, SOD, GIS, OFF, GME, ERI, and LTL.

An average particle diameter of the zeolite is not particularly limited; however, the diameter s desirably less than at least a thickness (cell gap) of the liquid crystal layer. More specifically, the diameter is preferably 0.1 μm or more to 15 μm or less.

The moisture absorbent usually accounts for 2 mass % or more to 18 mass % or less with respect to a total amount of the seal material. This range makes it possible to provide the liquid crystal display device that is high in moisture permeation resistance. The moisture absorbent desirably accounts for 5 mass % or more to 15 mass % or less.

### (3) Other Additives

The seal material may contain a curable resin having a (meth)acryloyl group. Examples of such a resin include (meth)acrylates. The (meth)acrylates are not particularly limited; and examples of the (meth)acrylates include urethane (meth)acrylates having a urethane bond and epoxy (meth)acrylates derived from glycidyl-containing compounds and (meth)acrylic acids.

The urethane (meth)acrylates are not particularly limited; and examples of the urethane (meth)acrylates include derivatives of dilsocyanates, such as isoborone diisocyanate, and reactive compounds that undergo addition reactions with isocyanates, such as acrylic acids and hydroxyethyl acrylate. These derivatives may be a chain extended by using caprolactone, a polyol, etc. As examples of the commercially-available derivatives there may be mentioned U-122P, U-340P, U-4HA, and U-1084A (all manufactured by Shin-Nakamura Chemical Co., Ltd.) and KRM 7595, KRM 7610, and KRM 7619 (all manufactured by Daicel-UCB Co., Ltd.).

The epoxy (meth)acrylates are not particularly limited; and examples of the epoxy (meth)acrylates include epoxy (meth)acrylates derived from epoxy resins, such as bisphenol A epoxy resins and polypropylene glycol diglycidylether, and (meth)acrylic acids. As examples of the commercially-available epoxy (meth) acrylates there may be mentioned EA-1020, EA-6320, and EA-5520 (all manufactured by Shin-Nakamura Chemical Co., Ltd.) and Epoxyester 70PA and Epoxyester 3002A (both manufactured by Kyoeisha Chemical Co., Ltd.). Examples of other (meth)acrylates include methyl methacrylate, tetrahydrofurfuryl methacrylate, benzyl methacrylate, isobornyl methacrylate, 2-hydroxyethyl methacrylate, glycidyl methacrylate, (poly)ethylene glycol dimethacrylate, 1,4-butanediol dimethacrylate, 1,6-hexanediol dirnethacrylate, trirnethylolpropane triacrylate, pentaerythritol triacrylate, and glycerin dimethacrylate.

Also suitably usable as the seal material are epoxy/(meth)acryl resins, as curable resins, having at least one (meth)acryl group and epoxy group each in one molecule.

Examples of the epoxy/(meth)acryl resins include compounds obtained by reacting a part of an epoxy group of the epoxy resins with a (meth)acrylic acid according to an ordinary method in the presence of a basic catalyst, compounds obtained by reacting 1 mol of isocyanate having two or more functional groups with ½ mol of a (meth)acryl monomer having a hydroxyl group and successively reacting the resulting product with ½ mol of glycidol, and compounds obtained by reacting a (meth)acrylate having an isocyanate group with glycidol. As examples of the commercially-available epoxy/(meth)acryl resins there may be mentioned MVAC 1561 (manufactured by Daicel-UCB Co., Ltd.).

The seal material may contain a silane coupling agent. The seal material having the silane coupling agent can improve adhesiveness between the seal material and the substrate.

The silane coupling agent is desirable that is highly effective in improving the adhesiveness with the substrates and can prevent an outflow of the curable resin into the liquid crystal material by chemically binding with the curable resin. Examples of the silane coupling agent to be suitably used include γ-aminopropyltrimethoxysilane, γ-mercaptopropyltrimethoxysilane, γ-glycidoxypropyltrimethoxysilane, γ-isocyanate propyltrimethoxysilane, and imidazole silane compounds having a structure in which an imidazole skeleton binds to an alkoxy silyl group through a spacer group. These silane coupling agents may be used independently, or two or more kinds may be used in combination.

The seal material may contain a filler for the purpose of, for example, improving the adhesiveness by a stress dispersion effect or improving a linear expansion coefficient, as long as these purposes do not run counter to the object of the present invention. The filler is not particularly limited; and examples of the filler include inorganic fillers such as silica, diatomaceous earth, alumina, zinc oxide, iron oxide, magnesium oxide; tin oxide, titanium oxide, magnesium hydroxide, aluminum hydroxide, magnesium carbonate, barium sulfate, calcium sulfate, plaster, calcium silicate, talc, glass beads, sericite activated earth, bentonite; aluminum nitride, and silicon nitride.

### (4) Preparation Method of Seal Material

To prepare the seal material, any of publicly-known mixing methods can be used.

### (5) Liquid Crystal Display Device

The liquid crystal display device is provided with the liquid crystal layer comprising the liquid crystal material, the sealing placed so as to surround the liquid crystal layer in plan configuration, and a pair of the substrates having the liquid crystal layer sandwiched therebetween. The sealing is constituted of a cured material of the seal material.

The liquid crystal display device is usually provided with an alignment film placed between the liquid crystal layer and the substrate, and also with an electrode between the alignment film and the substrate. The substrate, the electrode, and the alignment film are not particularly limited; and any publicly-known substrate, electrode, and alignment film can be used.

One example of the liquid crystal display device is illustrated in FIG. 2. FIG. 2 illustrates a schematic cross-section view of the one example of the liquid crystal display device in a general vertical alignment mode. The liquid crystal display device is not limited to the device of FIG. 2; and the device may be in any form of devices, as long as the devices have the sealing placed so as to surround the liquid crystal layer.

In FIG. 2, reference signs 1a and 1b each denote the substrate (e.g., a glass substrate); a reference signs 2a and 2b each denote the electrode; a reference signs 3a and 3b each denote the alignment film; a reference sign 4 denotes the liquid crystal layer; and a reference sign 5 denotes the sealing.

The liquid crystal layer can be formed by an injection of the liquid crystal material by an ODF process or a vacuum injection process. The ODF process and the vacuum injection process each may adopt publicly-known procedures.

The liquid crystal display device may be either a reflective device or a transmissive device.

Of the reflective liquid crystal display devices in particular—especially, vertical alignment-type liquid crystal display devices—it is difficult for these devices to have a wide viewing angle. To allow the devices to have the wide viewing angle, it is suggested that the liquid crystal layer should contain the liquid crystal material having a low refractive index anisotropy (Δn). The low Δn is preferably from 0.03 or higher to 0.08 or lower, and more preferably from 0.045 or higher to 0.075 or lower, in an environment at 20° C. and at wavelengths of 400 nm or more to 650 nm or less. Most of such liquid crystal materials low in Δn is a liquid crystal compound having a carboxyl group, which is hydroscopic, as represented by the following formulas A to C:

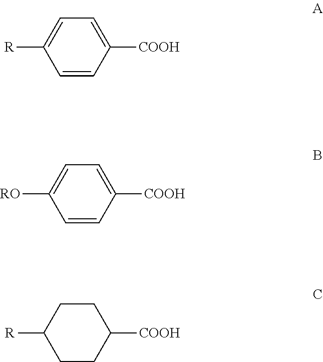

wherein R represents an alkyl group with 1 to 9 carbon atoms. The liquid crystal compound having the carboxyl group is likely to pull moisture from an outside environment; therefore, it is desired that the seal material should have the moisture permeation resistance.

Usable as the liquid crystal material is either a negative or positive dielectric anisotropy material.

From the other point of view, even if the liquid crystal display device has a narrow frame, the seal material having the moisture permeation resistance is desired. The seal material of the present invention is capable of complying with such a request.

### (6) How to Employ Seal Material

The seal material can be used to seal the liquid crystal material at a time when commonly-usable liquid crystal display devices are manufactured. Although how to employ the seal material may be different depending upon a type of the seal ingredient contained in the seal material, the seal material is applied to at least a part of a perimeter of one substrate so as to form a coating; another substrate is placed on the partially-coated substrate; and then these substrates are subjected to preliminary curing and main curing in order to seal the liquid crystal material. In the case of forming the liquid crystal layer by the ODF process, for example, the step for dropping the liquid crystal material into the substrate where is preliminarily cured with the seal material may be included in the ODF process. The liquid crystal layer can be also formed by the vacuum injection process through the following procedure: a pair of the substrates is sealed except for an injection inlet that is placed between the substrates; the liquid crystal material is injected through the injection inlet; and then the injection inlet is sealed with the seal material.

### EXAMPLES

### Example 1

### Preparation of Seal Materials

Five (5) types of moisture absorbent-containing seal materials were prepared by respectively mixing 5, 10, 15, 18, and 20 mass % of an SiO₄—AlO₄ crystal (Zeoal 4A manufactured by Nakamura Choukou Co., Ltd.) as a moisture absorbent with a commercially-available seal material for ODF (Photolec S (seal ingredient) manufactured by Sekisui Chemical Co., Ltd.) containing an epoxy monomer and a curing agent.

### Manufacturing of Test Cells

The following were prepared substrates A having an Al electrode and substrates B having an ITO electrode. On each of the substrates, a polyamic acid-based resin film for formation of vertical alignment film was formed by a coating method; the resin films were subjected to preliminary calcination at 80° C. for 2 min., and then were subjected to main calcination at 200° for 40 min., obtaining calcined films. The calcined films obtained were subjected to a rubbing treatment in order to obtain vertical alignment films. The five (5) types of the above-described moisture absorbent-containing seal materials and a moisture absorbent-free, commercially-available seal material were applied to a peripheral part of the substrates A, respectively, by lithography; and the substrates were subjected to preliminary curing at 90′ for 10 min. Subsequently, a negative liquid crystal material (Tₙᵢ=74.5° C., Δ_{ε}=−2.2, Δn=0.057 (589 nm, 20° C.)) comprising carboxyl group-containing compounds represented by formulas A to C as listed below was dropwise added onto the substrates A:

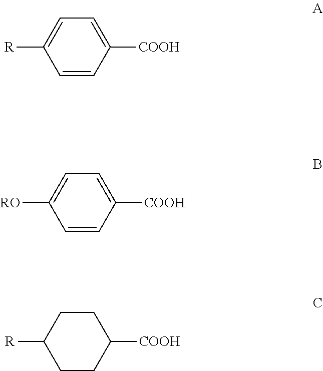

wherein R represents an alkyl group with 2 to 4 carbon atoms. Following that, the substrates A were pasted on the substrates B, respectively. A surface where a liquid crystal display will be shown is then covered with a mask, and only desired parts of the seal materials were subjected to ultraviolet irradiation (1 J/cm²). The seal materials were then subjected to calcination at 160° C. for 40 min. and were cured, manufacturing test cells (liquid crystal display devices) having a cell thickness of 2.8 μm to be subjected to an evaluation test.

### High-Humidity Environment Test

The test cells were measured for voltage holding ratios (hereinafter referred to as VHR) and residual DC (hereinafter referred to as rDC). Following that, the test cells were measured for VHR and rDC after having been left in a thermostat for 1,000 hours, where was maintained at 60° C. and 90% humidity.

The test cells were measured for VHR under conditions of 1 V, 70° C. by using a 6254-type VHR measurement system manufactured by TOYO Corporation. The test cells were measured for rDC by a flicker elimination method under conditions as follows. Namely, the test cells were measured for rDC after having been placed in an oven maintained at 40° C. while 2 V of a DC offset voltage was applied to the test cells for 2 hours. Table 1 below shows results thereby obtained.

TABLE 1

| | | |
|---|---|---|
| Content of | | |
| moisture | 0 hr. | After 1,000 hr. |

| absorbent | VHR | rDC | VHR | rDC |
|---|---|---|---|---|
| (mass %) | (%) | (V) | (%) | (V) |
| 0 | 98.0 | 0.02 | 88.5 | 0.19 |
| 5 | 98.0 | 0.02 | 93.5 | 0.07 |
| 10 | 98.0 | 0.02 | 93.8 | 0.06 |
| 15 | 97.7 | 0.01 | 95.1 | 0.04 |
| 18 | 97.9 | 0.01 | 92.8 | 0.08 |
| 20 | 97.8 | 0.02 | 90.8 | 0.10 |

In the high-humidity environment, the moisture absorbent-containing seal materials were capable of suppressing a VHR decrease and an rDC increase more effectively than the moisture absorbent-free seal material. Inter alia, the seal materials having the moisture absorbent content of 5 mass % or more to 18 mass % or less showed improvement effects much better in both the VHR and the rDC than the moisture absorbent-free seal material. This may be because the SiO₄—AlO₄ crystal as the moisture absorbent may have effectively absorbed (trapped) moisture from the outside.

The seal material having the moisture absorbent content of 20 mass % showed improvement effects lower in the VHR and the rDC than the seal materials having the moisture absorbent content of 5 mass % or more to 18 mass % or less. This may be because in the case where the moisture absorbent content was high, the hardness of the seal ingredient may have decreased. The reason why the seal ingredient was not easily cured may be that if there eras a high content of the SiO₄—AlO₄ crystal in the seal materials, the probability of reactions between the epoxy monomer and the curing agent may have become low.

### Example 2

In the same manner as in Example 1, substrates X and substrates Y were obtained, each of which comprises a vertical alignment film.

Five (5) types of moisture absorbent-containing seal materials, which were obtained in the same manner as in Example 1, and a moisture absorbent-free, commercially-available seal material were dropwise added onto the substrates X, respectively, in such a way as to make a diameter of the substrates X be 2 mm; and the two substrates were pasted in a cross shape as illustrated in FIG. 3. In this Figure, a reference sign 1 denotes a bonded part using the seal material. The seal materials were cured under the same conditions as in Example 1, manufacturing samples for evaluation of adhesion strengths. The samples thereby obtained were subjected to loads in a direction illustrated by arrows in FIG. 3; and adhesion strengths were measured as the loads, at times when the substrates X were peeled from the substrates Y. Table 2 below shows results thereby obtained.

TABLE 2

| Content of moisture | Adhesion strength |
|---|---|
| absorbent (mass %) | (kgf/mm) |
| 0 | 2.2 |
| 5 | 2.2 |
| 10 | 2.2 |
| 15 | 2.0 |
| 18 | 1.7 |
| 20 | 1.2 |

In view of this evaluation of adhesion strengths, the inventor considers that it is very unlikely that an adhesion strength of 1.5 kgf/mm or higher can prevent the entry of moisture from an alignment film-sealing interface and the peeling at the alignment film-sealing interface of the substrates.

As shown in Table 2, the content of the moisture absorbent of 18 mass % or less resulted in the adhesion strength of 1.5 kgf/mm or higher. However, the content of the moisture absorbent of 20 mass % resulted in the adhesion strength of less than 1.5 kgf/mm; and this may have caused the peeling of the substrates at the alignment film-sealing interface. The reason why the adhesion strengths decreased with the increase in the content of the moisture absorbent may be that if there is a high content of the moisture absorbent in the seal ingredient, the seal ingredient may be inhibited from being cured by polymerization of the seal ingredient (epoxy ingredient). The content of the moisture absorbent of 18 mass % or less is thus thought of as being appropriate.

### Example 3

In the same manner as in Example 1, a test cell was obtained by using a moisture absorbent-containing seal material in which a content of the moisture absorbent was 15 mass %. Also, another test cell was obtained in the same manner as described above, except that a negative liquid crystal material (Tₙᵢ=75° C., Δ_{ε}=−2.3, Δn=0.095 (589 nm, 20° C.)) that is free of the liquid crystal compounds A to C was used as a liquid crystal material.

The two test cells thereby obtained were measured for transmissivities (reflectivities) at their front side by using Photal 5200 (manufactured by Otsuka Electronics Co., Ltd.). The measurements were carried out at a range from 430 nm or more to 650 nm or less. The two test cells were measured for contrasts (front side, oblique angles of 20° and 40°) while any voltage was not applied, by using a luminance meter (SR-5000 manufactured by Topcon Corporation). The measurements of the transmissivities and the contrasts were carried out in an environment of 25° C. Table 3 below shows results thereby obtained.

TABLE 3

| Content of | Δn of | | | | |
|---|---|---|---|---|---|
| moisture | liquid | Transmissivity | Contrast | | |
| absorbent | crystal | (reflectivity) | Front | | |
| (mass %) | material | at front side | side | 20° | 40° |
| 15 | 0.057 | 18 | 3,300 | 2,800 | 2,000 |
| | 0.095 | 11 | 3,300 | 2,400 | 1,500 |

It is found from Table 3 that a reflective liquid crystal display device excellent in reflectivity and contrast can be provided by using the moisture absorbent-containing seal material. It is also found that it is better for the reflective liquid crystal display device to use the liquid crystal material that is low in Δn because loss of light is less, leading to the high transmissivity at the front side. In view of the extent of a decrease in the contrast in oblique directions, it is found that it is better to use the liquid crystal material that is low in Δn because the decrease in the contrast is a small, with the result that the liquid crystal display device with a wide viewing angle can be obtained. The liquid crystal material low in Δn is capable of lowering an amount of change in Δn in the oblique directions, with the result that a change in retardation is thought of as being less. It is thus effective that the reflective liquid crystal display device uses the low-Δn liquid crystal material.

### Example 4

Five (5) types of moisture absorbent-containing seal materials were prepared in the same manner as in Example 1, except that a commercially-available seal material for vacuum injection (World Rock 700 series manufactured by Kyoritsu Chemical & Co., Ltd.) was used.

In the same manner as in Example 1, substrates A and substrates B were obtained, each of which comprise a vertical alignment film. The five (5) types of the above-described moisture absorbent-containing seal materials and a moisture absorbent-free, commercially-available seal material were applied to a peripheral part of the substrates A, respectively, by lithography except where a vacuum injection inlet is; and the substrates were subjected to preliminary curing at 90° for 10 min. Following that, the substrates A were pasted on the substrates B, respectively. The seal materials were then subjected to calcination at 160° C. for 40 min. and were cured. A positive liquid crystal material (Tₙᵢ=75.5° C., Δ_{ε}=7.2, Δn=0.055 (589 nm, 20° C.)) comprising carboxyl group-containing compounds represented by formulas D to F as listed below, was injected through the vacuum injection inlet:

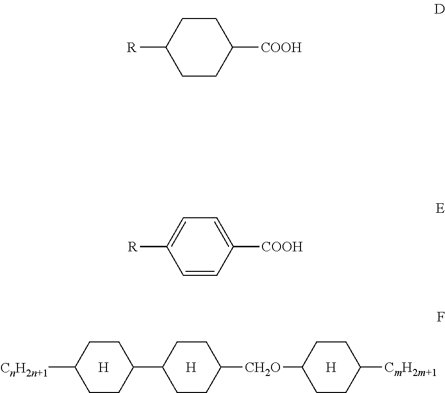

wherein the compound represented by the formula D has —C₃H₇ as R; the compound represented by the formula E has —C₂H₅ as R; and the compound represented by the formula F is a mixture of a compound F1, in which n=2 and m=3, and a compound F2, in which n=3 and m=4; and after the injection, the vacuum injection inlet was sealed, manufacturing test cells having a cell thickness of 2.8 μm to be subjected to an evaluation test. The positive liquid crystal material comprises about 35 mass % of the compound represented by the formula D, about 25 mass % of the compound represented by the formula E, about 15 mass % of the compound F1 , about 10 mass % of the compound F2, and about 15 mass % of a carboxyl group-free neutral ingredient. The test cells thereby obtained were subjected to a high-humidity environment test in the same manner as in Example 1. Table 4 below shows results thereby obtained.

TABLE 4

| | | |
|---|---|---|
| Content of | | |
| moisture | 0 hr. | After 1,000 hr. |

| absorbent | VHR | rDC | VHR | rDC |
|---|---|---|---|---|
| (mass %) | (%) | (V) | (%) | (V) |
| 5 | 99.2 | 0.00 | 97.1 | 0.04 |
| 10 | 99.1 | 0.00 | 97.5 | 0.04 |
| 15 | 99.1 | 0.02 | 97.2 | 0.05 |
| 18 | 99.1 | 0.01 | 95.0 | 0.05 |
| 20 | 99.2 | 0.00 | 93.3 | 0.09 |
| 0 | 99.2 | 0.01 | 92.1 | 0.10 |

In the high-humidity environment, even though the liquid crystal compound was injected by the vacuum injection, the moisture absorbent-containing seal materials were capable of suppressing a VHR decrease and an rDC increase more effectively than the moisture absorbent-free seal material. Inter alia, the seal materials having the moisture absorbent content of 5 mass % or more to 18 mass % or less showed improvement effects much better in both the VHR and the rDC than the moisture absorbent-free seal material. This may be because the SiO₄—AlO₄ crystal as the moisture absorbent may have effectively absorbed (trapped) moisture from the outside.

The seal material having the moisture absorbent content of 20 mass % showed improvement effects lower in the VHR and the rDC than the seal materials having the moisture absorbent content of 5 mass % or more to 18 mass % or less. This may be because the moisture absorbent content was higher; therefore, the hardness of the seal ingredient may have decreased. The reason why the seal ingredient is not easily cured may be that if the seal materials have a high content of the SiO₄—AlO₄ crystal, the probability of reactions between the epoxy monomer and the curing agent may become low.

### Example 5

In the same manner as in Example 4, test cells before injecting any liquid crystal materials were obtained by using a moisture absorbent-containing seal material in which a content of the moisture absorbent was 15 mass %. Five (5) types of negative liquid crystal materials were prepared that were different in Δn (Δn=0.047, 0.052, 0.057, 0.071, 0.095 (589 nm, 20° C.)). The more a total amount of the liquid crystal compounds A to C is, the lower the Δn becomes. The liquid crystal material having Δn=0.095 signifies the negative liquid crystal material that does not contain any of the liquid crystal compounds A to C. The test cells were obtained in the same manner as in Example 4, except that these negative liquid crystal materials were used. The test cells thereby obtained were subjected to a high-humidity environment test in the same manner as in Example 1. Table 5 below shows results thereby obtained.

TABLE 5

| | | | |
|---|---|---|---|
| Content of | Δn of | | |
| moisture | liquid | 0 hr. | After 1,000 hr. |

| absorbent | crystal | VHR | rDC | VHR | rDC |
|---|---|---|---|---|---|
| (mass %) | material | (%) | (V) | (%) | (V) |
| 15 | 0.047 | 98.0 | 0.05 | 96.1 | 0.10 |
| | 0.052 | 98.7 | 0.02 | 97.0 | 0.07 |
| | 0.057 | 98.7 | 0.02 | 97.0 | 0.06 |
| | 0.071 | 99.0 | 0.00 | 97.7 | 0.03 |
| | 0.095 | 99.1 | 0.00 | 97.7 | 0.04 |

As shown in Table 5, the test cells with any of the above-shown Δn are capable of suppressing a VHR decrease and an rDC increase in the high-humidity environment, are capable of lowering an amount of change in the VHR and the rDC even in a range of Δn of the reflective liquid crystal display device from 0.03 or higher to 0.08 or lower, and do not impair any display quality such as developing a flicker. Moreover, the higher the Δn is, the more the test cells demonstrate a tendency to suppress the VHR decrease and the rDC increase; and in the case where the Δn becomes 0.095 or higher, the contrasts decrease significantly.

### DESCRIPTION OF REFERENCE SIGNS

1a and 1b substrate, 2a and 2b electrode, 3a and 3b alignment film, 4 liquid crystal layer, 5 sealing, A and B pore, X and Y substrate, 1 bonded part

What is claimed is:

1. A seal material for liquid crystal display device comprising a seal ingredient including an epoxy monomer and a curing agent, and a moisture absorbent, wherein the moisture absorbent comprises a crystalline compound containing SiOₓ (wherein x=1 or higher to 8 or lower) and AlO_{y} (wherein y=1 or higher to 8 or lower); and the moisture absorbent is contained 5 mass % or more to 18 mass % or less with respect to a total amount of the seal material for liquid crystal display device.

2. The seal material for liquid crystal display device according to claim 1, wherein SiOₓ is SiO₄, and the AlO_{y} is AlO₄.

3. A liquid crystal display device comprising:
a liquid crystal layer comprising a liquid crystal material;
a sealing placed so as to surround the liquid crystal layer in plan configuration; and
a pair of substrates having the liquid crystal layer sandwiched therebetween,
wherein the sealing is a cured form of the seal material for liquid crystal display device comprising a seal ingredient including an epoxy monomer and a curing agent, arid a moisture absorbent,
wherein the moisture absorbent comprises a crystalline compound containing SiOₓ (wherein x=1 or higher to 8 or lower) and AlO_{y} (wherein y=1 or higher to 8 or lower), and the moisture absorbent is contained for 5 mass % or more to 18 mass % or less with respect to a total amount of the seal material for liquid crystal display device.

4. The liquid crystal display device according to claim 3, wherein SiOₓ is SiO₄, and the AlO_{y} is AlO₄.

5. The liquid crystal display device according to claim 3, wherein a refractive index anisotropy Δn of the liquid crystal material is from 0.03 or higher to 0.08 or lower,

6. The liquid crystal display device according to claim 5, wherein the refractive index anisotropy Δn of the liquid crystal material is from 0.045 or higher to 0.075 or lower,

7. The liquid crystal display device according to claim 3, wherein the liquid crystal material is either a negative or positive dielectric anisotropy.

8. The liquid crystal display device according to claim 3, wherein the liquid crystal material comprises a liquid crystal compound having a carboxyl group.

9. The liquid crystal display device according to claim 8, wherein the liquid crystal compound comprises at least one of the compounds represented by the following formulas A to C: 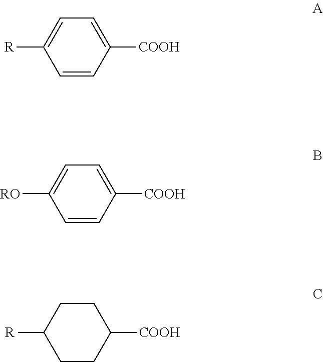
wherein R represents an alkyl group with 1 to 9 carbon atoms.

10. The liquid crystal display device according to claim 3, is a reflective device.
